(19) United States
(12) Patent Application Publication
(10) Pub. No.: US 2010/0084997 A1
(43) Pub. Date: Apr. 8, 2010

(54) MULTI-MODE UTILITY LIGHTING DEVICE

(76) Inventors: Joseph Anthony Oberzeir, San Francisco, CA (US); Sheik Ahmed, San Jose, CA (US); Raul Michael Urrutia, Hacienda Heights, CA (US)

Correspondence Address: DOUGLAS L WELLER, 431 MAGNOLIA LANE, SANTA CLARA, CA, 95051, US

(21) Appl. No.: 12/571,337

(22) Filed: Sep. 30, 2009

Related U.S. Application Data
(60) Provisional application No. 61/102,108, filed on Oct. 2, 2008.

(51) Int. Cl. H05B 39/00; H01J 1/62

(52) U.S. Cl. 315/313; 313/504; 362/183

(57) ABSTRACT

A lighting device that includes a handle, a head control circuitry and a switching mechanism. The handle is adapted to being gripped and held by a human hand. The head includes a heat sink with a plurality of facets and a plurality of light panels. Each facet of the heat sink is in a different plane than other facets of the heat sink. The light panels are mounted on the heat sink. Each light panel is mounted on a different facet of the heat sink. The control circuitry causes the plurality of light panels to emit light in a plurality of user selectable light patterns. The switching mechanism allows a user to select light patterns from among the plurality of user selectable light patterns.

### RELATED APPLICATIONS

The present application claims the benefit of prior filed co-pending provisional application having a provisional application number of 61/102,108, filed on Oct. 2, 2008.

### BACKGROUND

Incendiary flares have been used for many years to indicate dangerous road conditions and otherwise attract attention or issue a warning. However, the typical burn temperatures of incendiary flares can reach 5000 degrees Fahrenheit, making incendiary flares a significant fire hazard. Additionally, toxic chemicals contained within incendiary flares can be hazardous to those who handle and use the flares as well as create environmental pollutants.

As a result, there has been a movement to replace incendiary flares with light emitting diode (LED) flares, some of which are built in the shape of a hockey puck. While these are safer and more environmentally friendly than incendiary flares, they can lack versatility.

### BRIEF DESCRIPTION OF THE DRAWINGS

FIG. 1 is a simplified diagram showing two parts of a portable utility lighting device (PULD).

FIG. 2 is a simplified diagram showing printed circuit board panels used to implement the PULD shown in FIG. 1.

FIG. 3 is a simplified diagram showing views of the electrical connectors used to place in electrical connection the two parts of the PULD shown in FIG. 1.

FIG. 4 is a simplified diagram showing connected together the two parts of the PULD shown in FIG. 1.

FIG. 5 is a simplified diagram showing a different view of the PULD shown in FIG. 1.

FIG. 6, FIG. 7, FIG. 8 and FIG. 9 are simplified top down views of a PULD, illustrating operation of a ring switch incorporated into the PULD shown in FIG. 1.

FIG. 10 is a simplified block diagram of operational circuitry for the PULD shown in FIG. 1.

FIG. 11 is a simplified diagram showing an alternative embodiment of a PULD.

FIG. 12 is a simplified block diagram of operational circuitry for the PULD shown in FIG. 11.

FIG. 13 is a simplified block diagram of and alternative embodiment of operational circuitry for the PULD shown in FIG. 11.

### DESCRIPTION OF THE EMBODIMENT

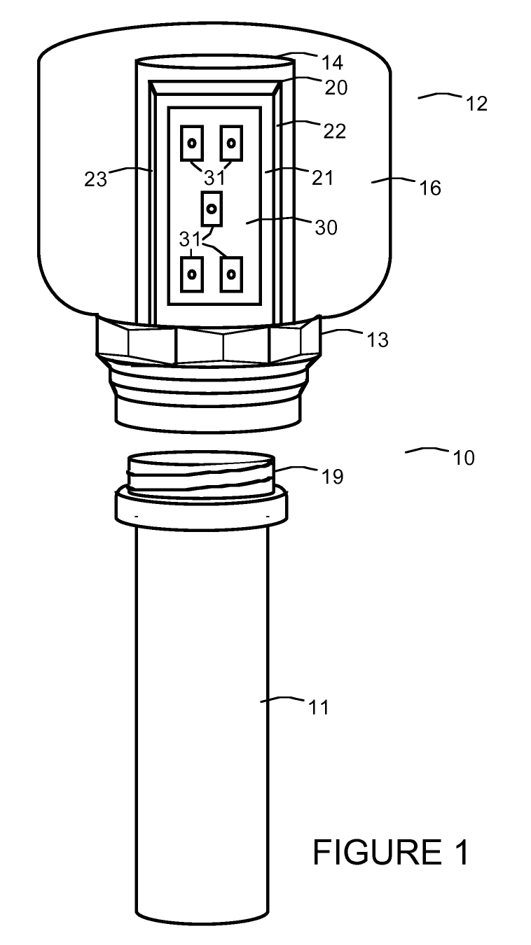

FIG. 1 is a simplified diagram showing a portable utility lighting device (PULD) 10. A handle 11 contains a battery power source for PULD 10. For example, the battery power source is rechargeable and when fully charged is arranged to provide a 9.6 to 12 volt power signal. Other arrangements can be used in accordance with power needs of PULD 10. Screw threads 19 are used to attach handle 11 to a head 12 of PULD 10. Alternatively, a twist lock or some other attachment scheme can be used to attach handle 11 to head 12.

Head 12 includes a ring switch 13 which can be rotated to change the operating modes of PULD 10. For example the inside of ring switch 13 is composed of plastic with a relatively low co-efficient of friction, such as polyoxymethylene (POM), polyethylene or polypropylene. The low coefficient of friction facilitates rotation of ring switch 13 with respect to the rest of head 12. As ring switch 13 is rotated with respect to head 12, locking positions, also called are encountered. The locking positions are implemented, for example, by a detent, such a bead or plunger mechanism on head 12 of PULD 10 settling into an indentation within the underside of ring switch 13. The locking positions are used to provide feedback to a user that switch ring switch 13 has reached a valid detect lock position for an operating mode of PULD 10. When ring switch 13 is in a locking position, exertion of additional force allows switch ring switch 13 to continue rotation around head 12 to other detect lock positions.

A printed circuit board 30 is mounted on a facet 21 of a heat sink 20. For example, heat sink 20 is made of aluminum or some other material that is able to transport heat away from printed circuit board 30. LEDs 31 are mounted on printed circuit board 30 to form a light panel. LEDs 31 emit light in accordance with the operating mode selected using switch ring switch 13. The number and arrangement of LEDs mounted on printed circuit board 30 is illustrative and depends on the design goals and constraints of PULD 10.

The color and light emitting capacity of LEDs 31 can be selected based on the intended use or uses of PULD 10. For example, LEDs 31 are red LEDs that provide greater than 60 lumens each. Alternately, LEDs 31 are white LEDS, other colors of LEDs, or a mixture of colors of LEDs.

Heat sink 20 is protected by protective material 14, which is for example, composed of a hard transparent material such as polymethyl methacrylate (PMMA), or another form of acrylic, hard plastic or glass.

An outer shell 16, can be formed of hard or soft material that is transparent, clear translucent or color translucent. For example, outer shell 16 can be composed of a soft material such as cast or injection molded urethane or polyurethane or a hard material such as acrylic.

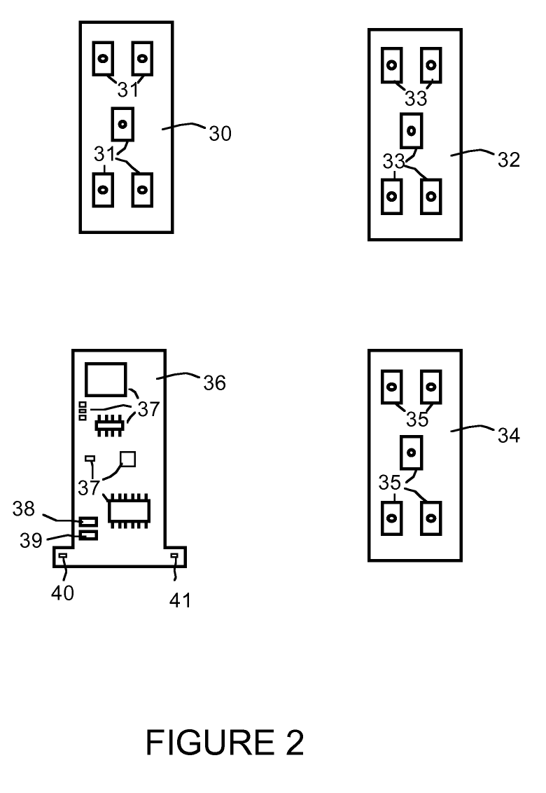

FIG. 2 shows printed circuit boards that are mounted on facets of heat sink 20. For example, shown in FIG. 2 is printed circuit board 30, which in FIG. 1 is shown to be mounted on a facet 21 of heat sink 20. A printed circuit board 32 is mounted on a facet 22 (shown in FIG. 1) of heat sink 20. LEDs 33 are shown mounted on printed circuit board 32 to form a light panel. A printed circuit board 34 is mounted on a facet 23 (shown in FIG. 1) of heat sink 20. LEDs 34 are shown mounted on printed circuit board 33 forming a light panel.

While in various embodiments herein, LEDs are shown used to provide a high brightness light source, other sources of bright light such as plasma display technology and organic light emitting diodes (OLEDs) may be utilized instead of, or in conjunction with, LEDs to form light panels which are mounted on facets of heat sink 20.

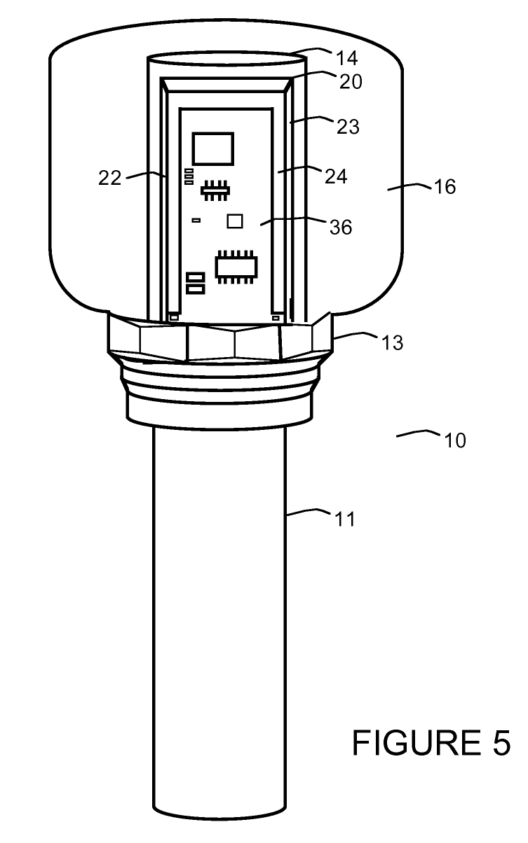

A printed circuit board 34 is mounted on a facet 24 (shown in FIG. 5) of heat sink 20. An LED 38 and an LED 39 are mounted on printed circuit board 36. Additional components, represented in FIG. 2 by components 37, are mounted on printed circuit board 36. The additional components are, for example, a processor, a voltage regulator, drivers for the LEDs, resistors, transistors and so on. A sensor 40 and a sensor 41 are used to detect the locked position of switch ring 13, shown in FIG. 1.

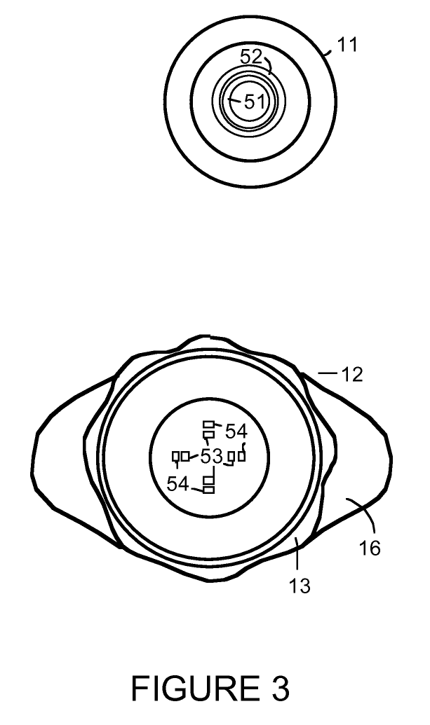

FIG. 3 shows a simplified top down view of handle 11 and a simplified bottom up view of head 12 in order to illustrate electrical connection between handle 11 and head 12. When handle 11 is connected to head 12, outer contacts 56 of head 12 are in physical and electrical contact with an outer conduction ring 52. Inner contacts 53 of head 12 are in physical and electrical contact with an inner conduction ring 51. This connection scheme facilitates handle 11 being detached from head 12 and attached to another head with different functionality. This connection scheme also facilitates handle 11 being detached from head 12 and head 12 being attached to another source of power (e.g., another handle with a charged battery power supply) in the event the battery power supply within handle 11 is discharged.

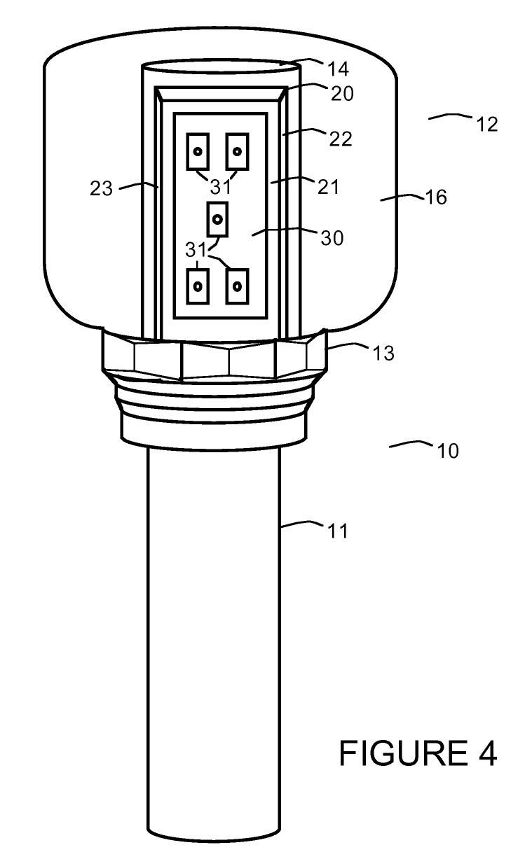

FIG. 4 shows a front view of PULD 10 when handle 11 has been connected to head 12. Visible in FIG. 4 are facet 21, facet 22 and facet 23 of heat sink 20.

FIG. 5 shows a back view of PULD 10 when handle 11 has been connected to head 12. Visible in FIG. 5 are facet 24, facet 22 and facet 23 of heat sink 20. Printed circuit board 36 is shown mounted on facet 24 of heat sink 20. Alternatively, printed circuit 36 or a replacement can be mounted on a facet of heat sink 20 that is not visible or is only partially visible from a user of PULD 10. One advantage of mounting printed circuit board 36 on facet 24 of heat sink 20 as shown is that there is a resulting dark side of PULD 10 which can face toward a user when holding up PULD 10. When PULD 10 is placed on the ground, the resulting dark side can be placed towards the ground. The oblong shape of outer shell 16 will prevent rolling so that facet 24 remains facing the ground.

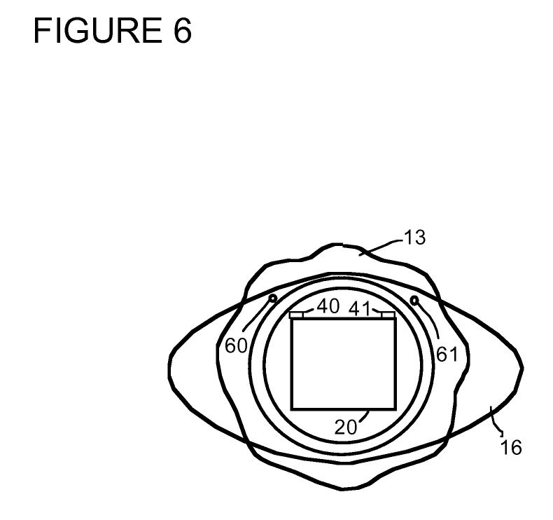

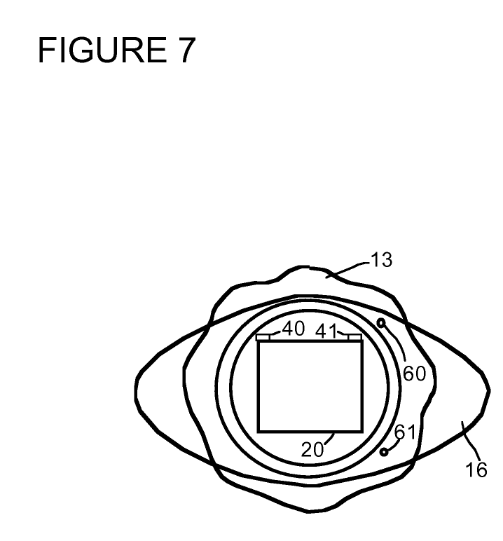

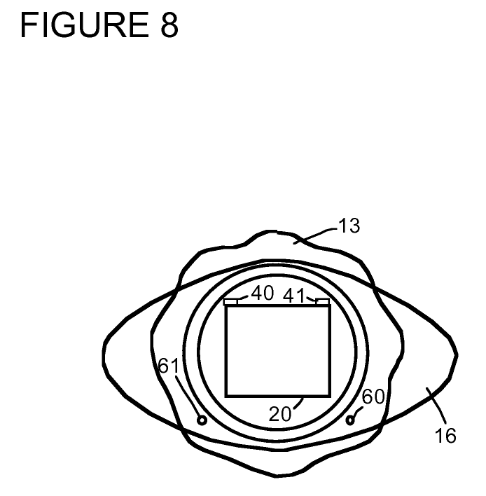

FIG. 6 is a simplified top down view of PULD 10 used to illustrate how sensor 40 and sensor 41, mounted on printed circuit board 36, are used to detect mode selections indicated by locked positions of ring switch 13. Locations where magnets are embedded within switch ring 13 are represented in FIG. 6 by circles. A first circle indicates the location of a magnet 60. A second circle indicates the location of magnet 61, as shown.

For example, sensor 40 detects the presence of a magnetic field when magnet 60 or magnet 61 is in close proximity to sensor 40, and sensor 41 detects the presence of a magnetic field when magnet 60 or magnet 61 is in close proximity to sensor 41. For example, sensors 40 and 41 are Hall effect sensors. In FIG. 6 switch ring 13 is in a first locked position where magnet 60 is in close proximity to sensor 40 and magnet 61 is in close proximity to sensor 41; therefore, both sensor 40 and sensor 41 detect the presence of a magnetic field.

In FIG. 7, switch ring 13 has been rotated 90 degrees to a second locked position. In the second locked position magnet 60 is in close proximity to sensor 41. No magnet is in close proximity to sensor 40; therefore, only sensor 41 detects the presence of a magnetic field.

In FIG. 8, switch ring 13 has been rotated another 90 degrees to a third locked position. In the third locked position no magnet is in close proximity to either sensor 40 or sensor 41; therefore, neither sensor 40 nor sensor 41 detect the presence of a magnetic field.

In FIG. 9, switch ring 13 has been rotated another 90 degrees to a fourth locked position. In the fourth locked position magnet 61 is in close proximity to sensor 40. No magnet is in close proximity to sensor 41; therefore, only sensor 40 detects the presence of a magnetic field.

While FIGS. 6 through 9 illustrate four locked positions being used to indicate four operational modes, other switching configurations also can be used. For example, by varying the number and location of magnets and sensors, a ring switch can be implemented to indicate, for example, two, three, five or more operating modes.

While FIGS. 6 through 9 show detection of operating modes being accomplished using magnets and magnetic sensors, other technology can be used to detect positions of switch ring 13. For example, sensors 40 and 41 can be implemented using inductive sensors, capacitive sensors or optical sensors instead of magnetic sensors.

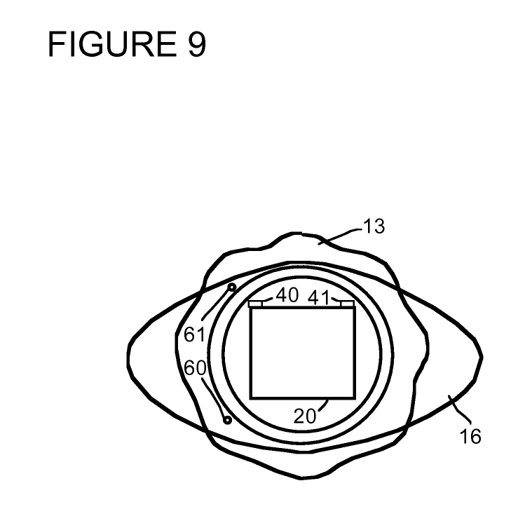

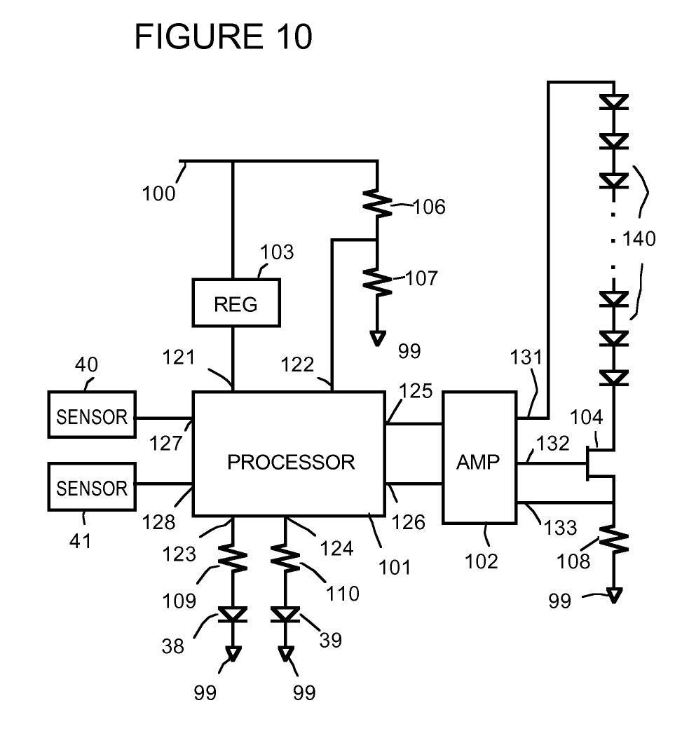

FIG. 10 shows a simplified schematic for PULD 10. Battery power source within handle 11 supplies a direct current (DC) power signal 100 and a ground signal 99. A regulator 103 supplies the power signal to a processor 101. A voltage divider, consisting of a resistor 106 and a resistor 107, supplies a signal to an analog to digital converter (ADC) input 122 of processor 101.

Sensor 40 is connected to a sensor input 127 of processor 101. Sensor 41 is connected to a sensor input 128 of processor 101. An output 123 of processor 101 is connected through a resistor 109 to LED 38. An output 124 of processor 101 is connected through a resistor 110 to LED 39.

Processor 101 monitors charge level of the battery power source of PULD 10 through the value detected by ADC input 122. The charge level is communicated to a user of PULD 10 through LED 38 and LED 39. For example, LED 38 is a yellow LED. When the voltage level on ADC input 122 indicates the battery power source of PULD 10 is less than or equal to 50% discharged, processor 101 periodically turns on LED 38. For example, LED 39 is a red LED. When the voltage level on ADC input 122 indicates the battery power source of PULD 10 is more than 50% discharged, processor 101 periodically turns on LED 39.

The selection of a two level indicator of charge is a design choice. Additionally LEDs can be added to allow communication of battery charge with a different degree of resolution. These LEDs can be turned on and off in combination to provide even greater resolution. Also, the voltage divider and ADC input can be replaced with other devices to monitor battery charge. For example, a processor can be added to handle 11 to monitor battery discharge and communicate the current amount of charge to processor 101. Alternatively, circuitry can be added that allows processor 101 to directly monitor current discharge from the battery power source. And so on.

Processor 101 provides light patterns by communicating with an amplifier 102 through an on/off output 125 and a pulse width modulation output 126. The signal on on/off output 125 indicates to amplifier 102 when amplifier 102 should turn on LEDs in an LED string 140. The signal on pulse width modulation output 126 indicates to amplifier 102 the light pattern to be used when the LEDs in LED string 140 are turned on.

Amplifier 102 provides a power signal 131 to a string of LEDs 140. For example, string of LEDs 140 is composed of LEDs 31, LEDs 33 and LEDs 35 (shown in FIG. 2) connected in series. Amplifier 102 through a control signal output 132, places a control signal on a gate of field-effect transistor (FET) 104. In response to a first control voltage signal value level FET 104 turns on so that the power signal traverses LEDs 140 through resistor 108 to ground signal 99, turning on all of LEDs 140. In response to a second control signal voltage value level FET 104 turns off so that the power signal does not traverses LEDs 140, turning off all of LEDs 140. An ADC input 133 of amplifier 102 allows amplifier 102 to monitor current flow through LEDs 140. For example, amplifier 102 is a voltage boost amplifier that boosts voltage of power signal 131 sufficiently to supply a signal that provides turn-on voltage for all of LEDs 140. In FIG. 10, the LEDs are shown arranged in series as string of LEDs 140. However, this is merely a design choice, the LEDs can also be connected in parallel or in some other connection pattern provided the driver circuitry is adapted to turn the LEDs on and off as instructed by processor 101.

For example, processor 101 generates a light pattern based on values received from sensor 40 and sensor 41. For example, the four modes selectable using switch ring 13 (shown in FIG. 1) are implemented by processor 101 depending upon a selected embodiment.

For example, in a first embodiment of PULD 10 useful as a safety flare, LEDs 140 are red LEDs that emit red light with an approximate wavelength of 616 nanometers. In a first mode, as implemented by processor 101, LEDs 140 are turned off. In a second mode, LEDs are turned on in a pseudo random flicker pattern emulating the light of an incendiary flare. For example, the flicker pattern is a 0 to 20 hertz variation of light with an average duty cycle less than 40% and approximately 25%. In a third mode, processor 101 generates a strobe pattern with, for example, a 1 hertz pattern and a 12% duty cycle. In a fourth mode, processor 101 causes LEDs 140 to generate a light pattern that spells out SOS in Morse code, the whole SOS pattern being spelled out within approximately three seconds with a delay of approximately one second between each pattern.

When PULD 10 is in the second mode, the third mode or the fourth mode described above, and the voltage level on ADC input 122 indicates the battery power source of PULD 10 reaches a discharge threshold, for example when the battery power source is 90% discharged, processor 101 goes into special power saving mode. In the special power saving move, processor 101 causes a lower power light pattern to be utilized. For example, the lower power light pattern is a ½ hertz strobe with a 10% duty cycle. As the battery power supply continues to discharge, processor decreases the light frequency up to a ¼ hertz light pattern with a 5% duty cycle. When the battery power supply is 99% discharged processor 101 enters the first mode.

Processor 101 can also monitor temperature of heat sink 20 and/or the battery power source and reduce brightness and energy rate consumption when processor 101 detects a substantially elevated temperature.

In another embodiment of PULD 10, LEDs 140 are white light LEDs. In a first mode, as implemented by processor 101, LEDs 140 are turned off. In a second mode, as implemented by processor 101, LEDs 140 are turned on constantly providing a full bright light pattern suitable for use as a lantern. In a third mode, LEDs are strobed at a frequency greater than 100 Hertz with a 50% duty cycle to provide appearance to a user of a half bright lantern. In a fourth mode, processor 101 generates a strobe pattern with, for example, a 1 hertz pattern and a 10% duty cycle.

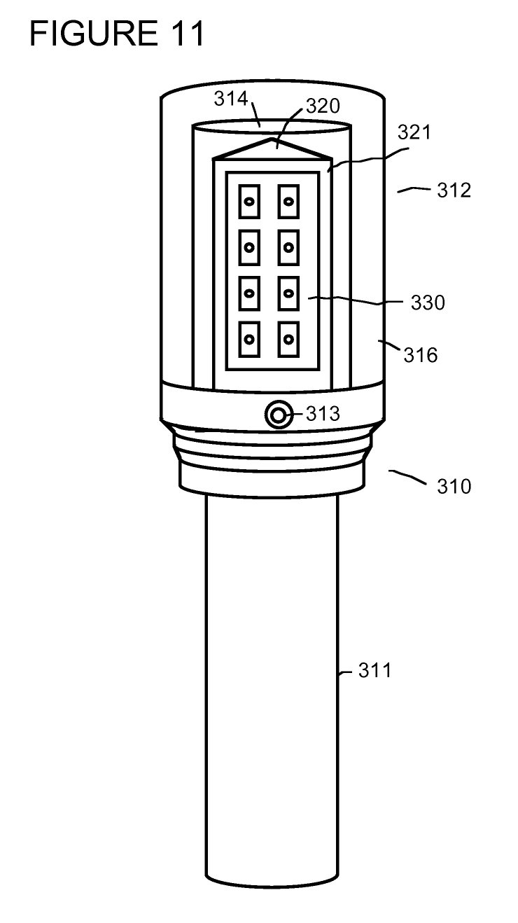

FIG. 11 shows a PULD 310 which has printed circuit boards mounted on three sides of a heat sink 320. FIG. 11 shows one of the printed circuit boards, a printed circuit board 330, mounted on a facet 321 of heat sink 320. For example, heat sink 320 is made of aluminum or some other material that is able to transport heat away from printed circuit board 330. LEDs 331 are mounted on printed circuit board 330 to form an LED panel. LEDs 331 emit light in accordance with the operating mode selected using a push button switch 313. The number and arrangement of LEDs mounted on printed circuit board 330 is illustrative and depends on the design goals and constraints of PULD 310.

The color and light emitting capacity of LEDs 331 are selected based on the intended use or uses of PULD 310. For example, LEDs 331 are half red LEDs and half white LEDS. Alternatively, LEDS 331 are other colors of LEDs, or other mixture of colors of LEDs.

LEDs may be mounted on printed circuit boards attached to the other two facets of heat sink 320. Alternatively, LEDs may be mounted on a printed circuit boards attached to one of the other two facets of heat sink 320, while the printed circuit boards attached to the other of the two remaining facets of heat sink 320 may be devoted to control circuitry. All the LEDs mounted on a printed circuit board may all emit light of the same color. Alternatively, LEDs mounted on a printed circuit board may emit light of different (e.g., two or more) colors, i.e., some may be blue LEDs, some may be white LEDs and some may be red LEDs.

Heat sink 320 is protected by protective material 314, which is for example, composed of a hard transparent material such PMMA, another acrylic, hard plastic or glass.

An outer shell 316, can be formed of hard or soft transparent material. For example, outer shell 316 can be composed of a softer transparent material such as cast or injection molded urethane or polyurethane.

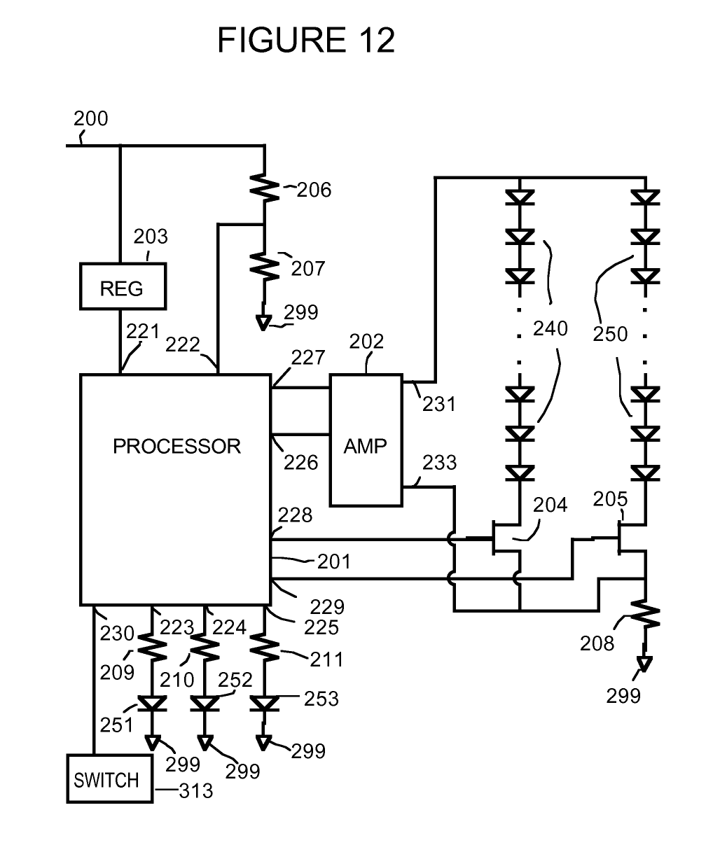

FIG. 12 shows a simplified schematic for PULD 20. Battery power source within handle 310 supplies a DC power signal 200 and a ground signal 299. A regulator 203 supplies the power signal to a processor 201. A voltage divider consisting of a resistor 206 and a resistor 207 supplies a signal to an analog to an ADC input 222 of processor 201.

Switch 313 is connected to a switch input 230 of processor 201. An output 223 of processor 201 is connected through a resistor 209 to an LED 251. An output 224 of processor 201 is connected through a resistor 210 to LED 252. An output 225 of processor 201 is connected through a resistor 211 to LED 253.

Processor 201 monitors charge level of the battery power source of PULD 310 through the value detected by an ADC input 222. The charge level is communicated to a user of PULD 310 through LED 251 LED 252 and LED 253. For example, LEDs 251-253 implement a bar graph display that indicates remaining hours of battery life. Alternatively, a numerical display or another form of display can be used to indicate to a user the estimated remaining battery life.

Processor 201 implements light patterns by communicating with an amplifier 202 through an on/off output 227 and a pulse width modulation output 226. The signal on on/off output 227 indicates to amplifier 202 when amplifier 202 should turn on LEDs in LED string 240 and LED string 250. The signal on pulse width modulation output 226 indicates to amplifier 202 the blinking pattern to be used when the LEDs in LED string 240 or LED string 250 are turned on. While in FIG. 12, two strings of LEDs are shown, additional strings of LEDs can be added, for example, when it is desired to separately display more than two colors.

Amplifier 202 provides a power signal 231 to a string of LEDs 240. For example, string of LEDs 240 is composed of LEDs of a first color mounted on printed circuit boards of PULD 310 while string of LEDs 250 is composed of LEDs of a second color mounted on printed circuit boards of PULD 310.

Processor 201 through a control signal output 228, places a control signal on a gate of a FET 204. In response to a first control voltage signal value level FET 204 turns on so that the power signal traverses LEDs 240 through resistor 208 to ground signal 299, turning on all of LEDs 240. In response to a second control signal voltage value level FET 204 turns off so that the power signal does not traverses LEDs 240, turning off all of LEDs 240.

Likewise, processor 201 through a control signal output 229, places a control signal on a gate of a FET 205. In response to a first control voltage signal value level FET 205 turns on so that the power signal traverses LEDs 250 through resistor 209 to ground signal 299, turning on all of LEDs 250. In response to a second control signal voltage value level FET 205 turns off so that the power signal does not traverses LEDs 250, turning off all of LEDs 250.

An ADC input 233 of amplifier 202 allows amplifier 202 to monitor current flow through LEDs 240 and LEDs 250. For example, amplifier 202 is a voltage boost amplifier that boosts voltage of power signal 231 sufficiently to supply a signal that provides turn-on voltage for all of LEDs 240 and LEDs 250.

Processor 201 generates a light patterns based on values received from switch 313. For example, in a first mode, LEDs 240 and LEDs 250 are both off. In a second mode LEDs 240 are continuously on and LEDS 250 are off. In a third mode LEDs 250 are continuously on and LEDS 260 are off. In a fourth mode both LEDs 240 and LEDs 250 are turned on and off together in a flicker pattern. In a fifth mode both LEDs 240 and LEDs 250 are turned on and off together in a strobe mode. In a sixth mode, LEDs 240 are turned on and off in a flicker pattern while LEDs 250 remain off. In a seventh mode, LEDs 250 are turned on and off in a strobe pattern while LEDs 240 remain off. In an eighth mode, LEDs 250 and LEDs are turned on and off in a Morse code SOS pattern.

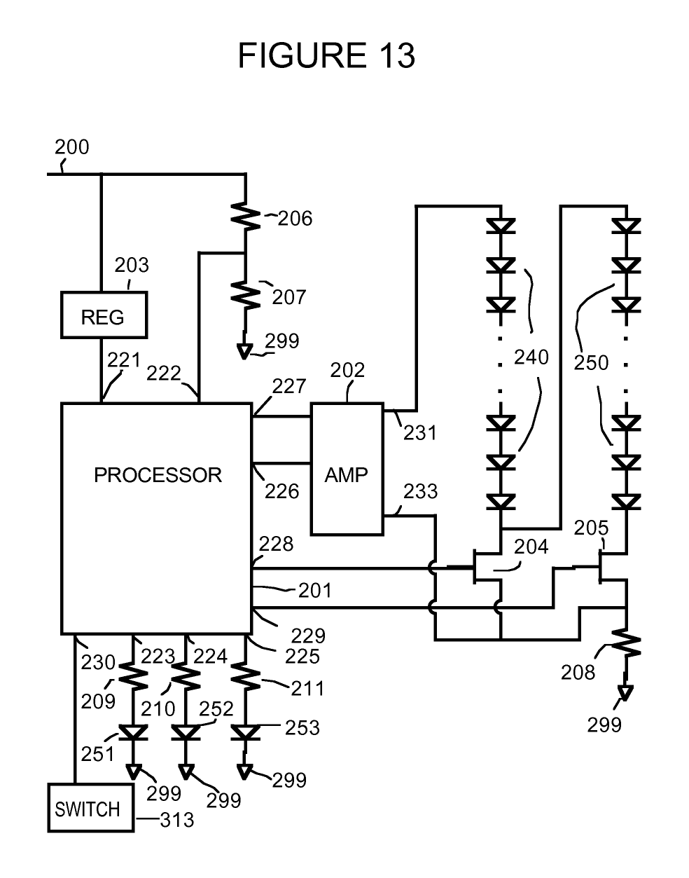

In other embodiments it may never be desirable to turn on LEDs 250 without turning on LEDs 240. In this case, LEDs 250 can be placed in a serial configuration with LEDs 240, as shown in FIG. 13.

Various enhancements can be based on the subject matter disclosed herein. For example, head 12 can include a refractive lens that provides increased brightness in one or more directions. For example, head 12 can include a transparent refractive lens that increases brightness in substantially two opposing directions. Alternatively, head 12 can include substantially diffusive materials that product a relatively uniform optical intensity of light emitted around head 12. Alternatively, optical intensity distribution of light from head 12 can be a substantially unidirectional optical intensity distribution where head 12 employs substantially parabolic shaped reflective materials in a manner similar to that of a flashlight reflector.

In other alternative embodiments, PULD 10 can include a remote communication capability, implemented, for example, using a radio frequency (RF) transceiver. Alternatively, remote communication can be implemented within PULD 10 using an infrared (IR) transceiver, or using subliminal light source modulation. The communication capability can be used to remotely annunciate battery energy state. The communication capability can also be used to remotely control PULD 10. The communication capability can also be used to discover proximity to other, substantially nearby devices.

Operating modes of PULD 10, selected for example, by a ring switch, pushbutton, or remote device, etc., can, for example, include a chasing mode similar to that of theater marquee signs where adjacent light sources are turned on and off in such a manner that a travel directions is visually indicated. PULD 10 can also use the communication capability to broadcast and receive messages and an algorithm or algorithms to effect chasing. For example, a locking position of ring switch 13 can be labeled “Chase Mode”. When switched into chase mode, PULD 10 listens for a predetermined interval for other device transmissions. Upon detecting none other, PULD 10 assigns itself “Number 1 Device”, stops listening, and begins periodic strobe flashing. PULD 10 further transmits a short broadcast message synchronous with the same periodicity, announcing its presence and self-assigned number. Subsequent devices, similar to PULD 10, upon being switched into chase mode, each listen for the predetermined interval, remember the highest sender ordinal number in sequence, assigns itself the next ordinal number and thereupon receiving each such message from its predecessor, waits a short but visually perceptive delay of time and then strobes a light source and then transmits a synchronous message containing its self-assigned ordinal number. An example of a visually perceptive delay of time is 100 milliseconds. In this manner all subsequent devices are self-assigned a number, with the resulting delayed light chasing effect between adjacent devices. In any listening interval, should a predecessor's message not be received, a device beings a periodic strobe and transmission, retaining its assigned number. In this way, should any device become inoperative, chase effect is maintained and substantially self-healing.

PULD 10 can also employ a removable flotation device, self-righting so that head 12 is substantially above the waterline. The floatation device can include reflector material arranged to minimize the loss of light into water surrounding PULD 10.

PULD 10 can include a removable tether attachment to used to attach PULD 10 to another object or person.

An attachment apparatus can be used to attach PULD 10 to a roadside cone shaped device. For example, the attachment apparatus is a threaded nut on the inside of the cone which mates to threads on the exterior of PULD 10. Alternatively, the attachment apparatus is a tether affixed to the inside of the cone and attached to PULD 10 by a key chain clip. The key chain claim can serve as a deterrent to theft.

Mounting PULD 10 on a roadside cone serves to increase the height at which PULD 10 is located, increasing visibility of PULD 10. The use of an attachment apparatus to secure PULD 10 to a cone decreases the chance of PULD 10 being turned into a projectile in the event PULD 10 is hit by a moving vehicle at high speeds.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

We claim:

1. A safety flare useful for providing warning about dangerous road conditions, the safety flare comprising:
a handle adapted to being gripped and held by a human hand;
a head, including:
a heat sink with a plurality of facets, each facet of the heat sink being in a different plane than other facets of the heat sink, and
a plurality of light panels mounted on the heat sink, each light panel being mounted on a different facet of the heat sink;
control circuitry that causes the plurality of light panels to emit light in a plurality of user selectable light patterns; and
a switching mechanism that allows a user to select light patterns from among the plurality of user selectable light patterns.

2. A safety flare as in claim 1 wherein the handle contains a battery power supply for the safety flare.

3. A safety flare as in claim 1 wherein the handle contains a battery power supply for the safety flare, the handle being detachable from the head allowing for a quick power supply change for the head.

4. A safety flare as in claim 1 wherein the light panels comprise light emitting diodes (LEDs) mounted on a printed circuit board.

5. A safety flare as in claim 1 wherein the light panels comprise red LEDs mounted on a printed circuit board, the red LEDs each emitting light at an intensity greater than 60 lumens.

6. A safety flare as in claim 1 wherein the light panels comprise organic light emitting diodes (OLEDs) mounted on a printed circuit board.

7. A safety flare as in claim 1 wherein the plurality of light patterns includes a pseudo random flicker pattern emulating the light of an incendiary flare.

8. A safety flare as in claim 1 wherein the plurality of light patterns includes a pseudo random flicker pattern emulating the light of an incendiary flare, the flicker pattern including a substantially 0 to 20 hertz variation of light with an average duty less than 40 percent.

9. A safety flare as in claim 1 wherein the plurality of light patterns includes a light pattern that spells out SOS in Morse code.

10. A safety flare as in claim 1 wherein the plurality of light patterns includes:
a pseudo random flicker pattern emulating the light of an incendiary flare;
a light pattern that spells out SOS in Morse code; and
a strobe pattern.

11. A safety flare as in claim 1 wherein the switching mechanism is a ring switch, comprising a ring that is user rotatable to select a light pattern from the plurality of light patterns.

12. A safety flare as in claim 1 wherein the switching mechanism is a push button switch.

13. A safety flare as in claim 1 additionally comprising a battery charge indicator, the battery charge indicator providing to the user an indication of battery charge.

14. A safety flare as in claim 1 wherein the control circuitry causes the plurality of light panels to emit light in power saving light pattern when estimated battery charge is below a predefined threshold.

15. A safety flare as in claim 1 wherein the control circuitry causes the plurality of light panels to emit light in power saving light pattern when estimated battery charge is below a predefined threshold, the power saving mode being a strobe pattern where a duty cycle of the strobe pattern decreases as estimated battery charge decreases.

16. A safety flare as in claim 1 wherein the handle contains a battery power supply for the safety flare, the handle being detachable from the head and adapted to allow connection to other devices with different functionality than the head.

17. A lighting device comprising:
a handle adapted to being gripped and held by a human hand, the handle contains a battery power supply for the lighting device;
a head, including:
a heat sink with a plurality of facets, each facet of the heat sink being in a different plane than other facets of the heat sink, and
a plurality of light panels mounted on the heat sink, each light panel being mounted on a different facet of the heat sink;
control circuitry that causes the plurality of light panels to emit light in a plurality of user selectable light patterns; and
a switching mechanism that allows a user to select light patterns from among the plurality of user selectable light patterns.

18. A lighting device as in claim 17 wherein each light panel from the plurality of light panels emits different color light.

19. A lighting device as in claim 17 wherein each light panel from the plurality of light panels is comprised of red LEDs and white LEDs mounted on a printed circuit board.

20. A lighting device as in claim 17 wherein each light panel from the plurality of light panels is comprised of white LEDs mounted on a printed circuit board.

21. A lighting device as in claim 17 wherein the switching mechanism is a ring switch, comprising a ring that is user rotatable to select a light pattern from the plurality of light patterns.

22. A lighting device as in claim 17 wherein the plurality of light patterns includes:
a full intensity pattern where the light panels are constantly on;
a half intensity pattern where the light panels are strobed on with a pattern greater than 100 Hertz and a 50 percent duty cycle; and
a strobe pattern where the light panels are strobed on with a duty cycle less than 50 percent.

23. A lighting device as in claim 17 wherein the plurality of light patterns includes:
a full intensity pattern where the light panels are constantly on;
a half intensity pattern where the light panels are strobed on with a pattern greater than 100 Hertz and a 50 percent duty cycle; and
a strobe pattern where the light panels are strobed on with a duty cycle less than 50 percent.

24. A lighting device as in claim 17 wherein the light panels are implemented using a first plurality of LEDs that emit light of a first color and a second plurality of LEDs that emit light of a second color, and where the plurality of light patterns includes at least two of the following patterns:
the first plurality of LEDs are constantly on and the second plurality of LEDs are constantly off;
the first plurality of LEDs are constantly off and the second plurality of LEDs are constantly on;
the first plurality of LEDs and the second plurality of LEDs are simultaneously turned on and off in a pseudo random flicker pattern emulating the light of an incendiary flare;
the first plurality of LEDs and the second plurality of LEDs are simultaneously turned on and off in a strobe pattern;
the first plurality of LEDs are constantly off and the second plurality of LEDs are turned on and off in a pseudo random flicker pattern emulating the light of an incendiary flare;
the second plurality of LEDs are constantly off and the first plurality of LEDs are turned on and off in a strobe pattern; and
the first plurality of LEDs are constantly off and the second plurality of LEDs are turned on and off in a light pattern that spells out SOS in Morse code.

25. A method for implementing a lighting device comprising:
providing power for the lighting device from a battery power source stored in a handle of the lighting device;
mounting light panels on different facets of a heat sink within a head of the lighting device;
utilizing control circuitry to control a plurality of light panels so that the light panels to emit light in a plurality of user selectable light patterns; and,
providing a switch that allows a user to select light patterns from among the plurality of user selectable light patterns.

26. A method as in claim 25 additionally comprising:
implementing the switch as a ring switch having a ring that is user rotatable to select a light pattern from the plurality of light patterns.
